(19) United States
(12) Patent Application Publication
(10) Pub. No.: US 2024/0119830 A1
(43) Pub. Date: Apr. 11, 2024

(54) SYSTEM AND METHOD FOR PREDICTING A FUTURE POSITION OF A ROAD USER

(71) Applicant: Continental Automotive Technologies GmbH, Hannover (DE)

(72) Inventors: Dominik Senninger, Burglengenfeld (DE); Matthias Wagner, Beutelsbach (DE)

(73) Assignee: Continental Automotive Technologies GmbH, Hannover (DE)

(21) Appl. No.: 18/481,466

(22) Filed: Oct. 5, 2023

(30) Foreign Application Priority Data
Oct. 5, 2022 (DE) 10 2022 210 504.4

(51) Int. Cl. G08G 1/01; G06N 3/08; G08G 1/16

(52) U.S. Cl. CPC G08G 1/0129; G06N 3/08; G08G 1/0112; G08G 1/0145; G08G 1/164; G08G 1/166

(57) ABSTRACT

The present disclosure relates to a system for predicting a future position of road users in a predefined road section, including a storage unit in which at least historical sensor data relating to captured road users in the predefined road section are stored. A processor is provided and extracts the historical movement data relating to the respective road users from the historical sensor data and is further designed to learn a sufficiently accurate high-definition map of the predefined road section by means of a machine learning method based on the historical movement data. The processor is further designed to determine, based on an input of current movement data relating to a road user, a prediction of at least one future position of this road user in this road section, at least implicitly using the learned high-definition map.

### CROSS-REFERENCE TO RELATED APPLICATIONS

The present application claims the benefit and/or priority of German Patent Application No. 10 2022 210 504.4 filed on Oct. 5, 2022, the content of which is incorporated by reference herein.

### TECHNICAL FIELD

The invention relates to a system and method for predicting a future position of road users in a predefined road section, comprising a storage unit in which at least the historical sensor data relating to the captured road users in the predefined road section are stored.

### BACKGROUND

Predictions of road users are required for many applications, especially also for systems for warning vulnerable road users. However, in order to achieve a prediction with the aid of conventional methods in a quality that allows a meaningful application of the prediction, it is necessary to have a highly accurate map available.

High-definition (HD) maps are highly precise, especially centimeter-accurate maps that can be used by autonomous vehicles, for example, to assist with the navigation of the vehicle. For this purpose, the HD maps can have a plurality of information layers that show the road geometry in the road. HD maps are usually made available to an autonomous vehicle by an HD map provider.

However, creating such an HD map is associated with high costs, and these maps are often not available on the market for pedestrians and cyclists. This dependence on manually created (and therefore expensive) highly accurate maps for all road users severely limits the practical use for warning.

Thus, U.S. Pat. No. 9,659,496 B2 discloses a method and a system for increasing the safety in a road network, comprising: an interaction detector having a communications interface for receiving a multiplicity of monitoring vectors of a first vehicle and a second vehicle moving in the road network; an interaction risk module designed to determine whether there is an interaction between the first vehicle and the second vehicle on the basis of the multiplicity of monitoring vectors, with the interaction being determined without use of prior knowledge about a preplanned route of each of the first vehicle and the second vehicle in the road network, and a message generator designed to generate a message for at least the second vehicle in response to the interaction risk module determining an interaction, and to transmit the message to the second vehicle via the communications interface.

U.S. Pat. No. 11,143,513 B2 discloses a computer-implemented method for generating a map for autonomous driving, wherein the method comprises the following: receiving perception data describing a set of trajectories driven by a multiplicity of vehicles navigating through a road section of a road over a period of time; performing an analysis using a set of rules for the set of trajectories in order to determine the driving behavior of the multiplicity of vehicles; determining a lane configuration of one or more lanes of the road segment based on the driving behavior of the multiplicity of vehicles, comprising: determining a number of lanes within the road segment based on the driving behavior of the multiplicity of vehicles within the road segment; and for each of the lanes, determining a lane width based on trajectory patterns of a multiplicity of trajectories within the lane; identifying a map segment of a navigation map corresponding to the road segment in order to include lane configuration information relating to the one or more lanes in order to generate a higher definition (HD) map, the lane configuration information including the number of lanes and the lane width of each lane, the HD map being used to generate a path in order to subsequently drive an autonomously driving vehicle autonomously; and transmitting the HD map to the autonomously driving vehicle in order to allow the autonomously driving vehicle to be controlled to drive on the road segment according to the path generated based on the HD map.

### SUMMARY

It is therefore an object of the present disclosure to provide a cheap and simple system and a method for predicting a future position of road users using a high-definition map.

A further object is also to provide a use of such a system and method.

The object is addressed by a system having the features of claim 1 and a method having the features of claim 7. Furthermore, the object is addressed by a use with the features of claim 14.

The object is addressed by a system for predicting a future position of road users in a predefined road section, including a storage unit in which at least the historical sensor data relating to the captured road users in the predefined road section are stored, and wherein a processor is provided and extracts the historical movement data relating to the respective road users from the historical sensor data and is further designed to learn a sufficiently accurate high-definition map of the predefined road section by means of a machine learning method based on the historical movement data, and wherein the processor is further designed to determine, based on an input of current movement data relating to a road user, a prediction of at least one future position of this road user in this road section, at least implicitly using the learned high-definition map.

The current movement data also includes a time span of past movement data relating to the road user.

By means of the system according to the present disclosure, a sufficiently accurate high-definition map for predicting the positions of the captured road users is learned based on historical movement data. For example, the sufficiently accurate high-definition map can be implicitly taken into account in an artificial neural network, for example, which is trained to predict positions of road users, or the sufficiently accurate high-definition map can be in the form of a vector map which can also be used for prediction.

Such a system makes it possible to avoid the complicated creation of a highly accurate map.

In a further embodiment, the learned, sufficiently accurate, high-definition map is in the form of a trained artificial neural network, wherein a computing unit is provided for the purpose of inputting current movement data relating to the road users in this road section into the artificial neural network generated in this way for predicting the future positions of the road users in this road section. As a result, the necessary map information is implicitly contained in the neural network. For each road section for which a prediction is to be made possible, a separate artificial neural network is trained with historical movement data from this road section and can provide results especially for this road section. Using a high-definition map trained as a neural network makes it possible to predict not only the positions of the lanes and footpaths, but also what speeds can be expected.

Furthermore, the processor may be designed to generate a relatively high-definition map as an artificial neural network at least based on relative historical positions of the road users as movement data, wherein the computing unit is designed to generate the relative future positions as a uniform time interval of a road user when inputting current movement data relating to the road users. Thus, for each road section for which a prediction is intended to be possible, a separate artificial neural network is trained with historical data from this road section and can provide optimal results especially for this road section.

Furthermore, the movement data may include, in addition to the relative historical positions of the road users, the relative historical speeds of the road users and/or the relative historical direction and/or the relative historical accelerations. Further movement data or Information can be, for example, information about other road users, etc.

Relative means, for example, from the point of view of coordinates of a vehicle/road user in its coordinate system.

This allows a relative prediction of the future positions of the road users in a predefined road section, for example an intersection, wherein the sufficiently accurate high-definition map information is implicitly contained in the trained artificial neural network. The artificial neural network is trained with historical data from this road section and generates a sufficiently accurate relative prediction, at least with respect to the future positions of the road user, in the event of an input from current movement data relating to the road user to be predicted and the environment thereof.

In a further embodiment, the movement data may comprise the absolute historical positions coupled at least to the relative historical positions, wherein the processor is designed to generate an absolute high-definition map as an artificial neural network at least using the historical relative and absolute positions of the road users, and wherein the computing unit is designed to generate the absolute future positions of the road user when inputting current movement data relating to a road user into the artificial neural network generated in this way.

Thus, the neural network implicitly trains a prediction that depends on the absolute position.

In a further embodiment, the processor is designed to generate historical swarm trajectories from the historical movement data and is further designed to generate a vector map from the historical swarm trajectories as a high-definition map for the road section, wherein a computing unit is provided and is designed to generate a prediction of the future positions of the road users in this road section using the current movement data and the vector map as a high-definition map.

Here, an average path for an observed swarm of vehicles on the observed road section can be defined and is referred to as a swarm trajectory for the specific road section.

For example, such historical swarm trajectories can be automatically generated from collected crowd data relating to the relevant road section. A high-definition map in the form of a vector map shows the lanes that show the routes used in reality and not the routes expected by a planner. Additional information may also be included, such as deviations from the optimal path. This allows a precise prediction of the positions of the road users when using current movement data.

Furthermore, the object is addressed by a method for predicting a future position of road users in a predefined road section, including the steps of:
providing at least historical sensor data relating to the captured road users in the predefined road section,
extracting historical movement data relating to the road users from the historical sensor data and learning a sufficiently high-definition map for the predefined road section by means of a machine learning method based on the historical movement data, and
determining, based on current movement data relating to a road user, a prediction of at least one future position of this road user in this road section, at least implicitly using the learned high-definition map.

The advantages of the system can be applied to the method. In particular, the method can be carried out on the system according to the present disclosure.

In a further embodiment, the learned high-definition map is in the form of a trained artificial neural network for inputting current movement data relating to the road users in this road section into the artificial neural network generated in this way for predicting the future positions of the road users in this road section.

In a further embodiment, the method includes the further step of:
generating a relatively high-definition map as an artificial neural network at least based on relative historical positions of the road users as movement data, and inputting current movement data relating to the road users into the artificial neural network in order to generate relative future positions of a road user.

The method may also include the further steps of:
generating an absolute high-definition map as an artificial neural network at least based on relative and absolute historical positions of the road users as movement data, and inputting current movement data relating to the road users into the artificial neural network generated in this way in order to generate absolute future positions of a road user.

Alternatively, the method may include the steps of:
generating historical swarm trajectories from the historical movement data, and generating a vector map as a high-definition map for the road section from the historical swarm trajectories, and generating a prediction of the future positions of the road users in this road section using the current movement data and the vector map as a high-definition map.

This generation of such a vector map can be achieved, for example, by the step of:
generating historical movement trajectories with a predefined length from the detected historical movement data as swarm trajectories.

In addition, including, for example, the further step of:
clustering the same or similar historical movement trajectories and creating routes from the respective clusters.

In addition, including, for example, the further step of:
converting relevant routes into directed graphs and dividing the directed graphs into lanes and generating a high-definition map based on the lanes.

This enables a vector map to be generated cost-effectively from swarm trajectories as a high-definition map for using predictions of captured road users for a limited road section.

Furthermore, the object is addressed by using a method as described above or a system as described above for predicting at least the future positions of the captured road users in a predefined road section in an alarm system for warning vulnerable road users in the predefined road section.

### BRIEF DESCRIPTION OF THE DRAWINGS

Further advantages and properties of the invention are clear from the following description, in which exemplary embodiments of the invention are explained in detail on the basis of the drawings. In the figures, in each case schematically:

FIG. 1: schematically shows a first method in a first configuration,

FIG. 2: shows the result of the method in the first configuration,

FIG. 3: schematically shows the method in a second configuration,

FIG. 4: shows the result of the procedure in the second configuration,

FIG. 5: shows a further configuration of the method according to the present disclosure,

FIG. 6: shows the result of clustering,

FIG. 7: shows a division of a lane.

### DETAILED DESCRIPTION

In particular, in the case of autonomously operated vehicles, a prediction of road users is necessary in order to thus be able to generate a warning for vulnerable road users. This should be able to be generated for all road users of a road section. For this purpose, it is necessary to use a highly accurate high-definition map. However, creating such a high-definition map is costly.

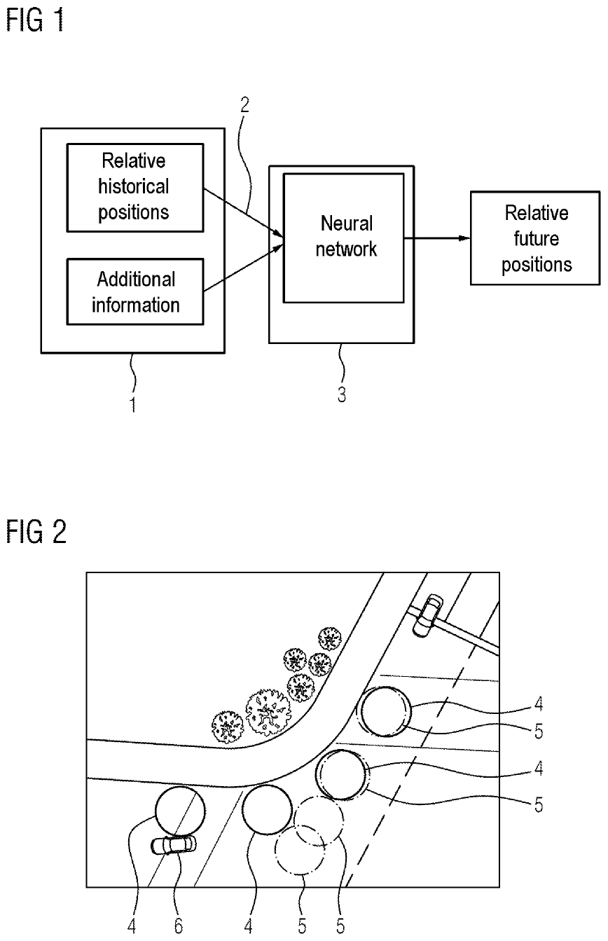

FIG. 1 schematically shows a method for predicting a future position of road users in a predefined road section in a first configuration by means of a simply generated high-definition map.

In this case, historical sensor data relating to the captured road users in the predefined road section, which are stored, for example, in a storage unit 1, are first of all provided.

The historical sensor data can each be provided with a time stamp.

The historical movement data relating to the road users are then extracted from the historical sensor data using a processor 2. These extracted and used sensor data essentially correspond to a historical movement trajectory with a time stamp.

A high-definition map can then be trained as an artificial neural network 3 for the predefined road section on the basis of the historical movement data. This is designed to be trained, on the basis of movement data, in particular the relative positions of the road users, to predict a future position of a road user, based on the predefined road section.

In addition to the relative positions as training data, the artificial neural network 3 can respectively receive, as historical movement data, the speed, direction and acceleration as training data as additional information.

Thus, the neural network 3 is trained at least on the basis of the relative historical positions of the road users in the road section. In addition, the neural network 3 can be trained on the basis of further information.

Additional information may be, for example, information about other road users, past speeds, or the like, which can be used to train the neural network 3. Such a trained neural network 3 can thus predict the relative future positions of a road user on this road section therefrom based on the current movement data relating to the road user as input.

Current movement data relating to the road user to be predicted and the environment thereof are therefore used to predict a future position of a road user. The current movement data can comprise the relative current positions, the current speed, the current direction and the current acceleration of the road user to be predicted and the environment thereof, with the result that, in addition to the future relative position, these future relative movement data can also be predicted. The current data also include past data, i.e., a time period up to the current data.

By virtue of a neural network 3 trained in this way, the high-definition map information is implicitly contained in the neural network 3. Based on the current movement data, the neural network 3 trained in this way can achieve very good results, especially for predicting the future relative position of the road user.

FIG. 2 shows the prediction result of such an artificial neural network 3. The first circles 4 show the true future positions in one, two, three and four seconds of the road user to be predicted, here of the vehicle 6, and the second circles 5 show the positions predicted by the neural network 3 in the form of a high-definition map, but a certain deviation is present.

FIG. 3 schematically shows a method for predicting a future position of road users in a predefined road section in a second configuration.

In turn, a neural network 3a to be trained receives the relative historical positions as a uniform time interval of the road users in the road section. In addition, however, the absolute position of the road users is also used for these data which are usually used. Thus, the neural network 3a implicitly learns a prediction that depends on the absolute position. This means that the artificial neural network 3a can generate an absolute prediction based at least on the absolute position of a road user. This in turn means that the absolute map information is implicitly contained in the neural network 3a.

The neural network 3a thus receives, as training data, the relative historical positions as a uniform time interval and the absolute positions in relation to a geographical coordinate system of a road user. The neural network 3a implicitly learns the map and topology of the intersection using the absolute positions and predicts the absolute future positions of a road user as a uniform time interval therefrom.

In addition, the neural network 3a can in turn be trained on the basis of further information. Additional information may be, for example, information about other road users, past speeds, or the like, which can be used to train the neural network 3a. Such a network 3a can thus predict the absolute future positions of road users on this road section therefrom based on the current and past movement data relating to a road user as input. Thus, the neural network 3a implicitly learns not only the positions of the lanes/footpaths, but also what speeds etc. can be expected.

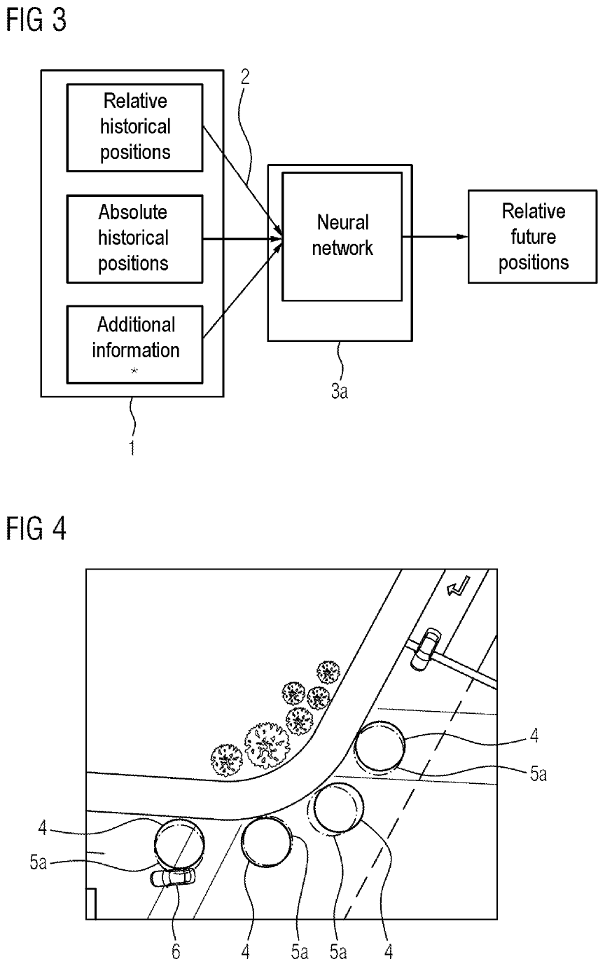

FIG. 4 shows the prediction result of a neural network 3a which was additionally trained with absolute positions and precisely for this intersection, i.e., the result of the method in the second configuration.

The first circles 4 again show the true future positions in one, two, three and four seconds, and the second circles 5a show the positions predicted by the neural network 3a in the form of a high-definition map.

Here the prediction and the real future positions match very well since it was implicitly learned that the vehicle 6 is in a turn lane and will turn. In addition, it was also recognized that the braking process will not be continued, as the braking seems to take place at this point usually before the actual turning process. This prediction of the speeds goes well beyond what can usually be derived from previous data points.

FIG. 5 shows a further configuration of a method according to the invention.

In this, the initially historical sensor data relating to the captured road users in the predefined road section, which are stored in a storage unit 1, are again provided.

The historical sensor data can each be provided with a time stamp.

The historical movement data relating to the road users are then extracted from the historical sensor data using the processor 2. These extracted and used sensor data essentially correspond to a historical movement trajectory with a time stamp. The movement data can respectively comprise the latitude, longitude, course, speed, time stamp, and information about each individual data point that can be used to filter out incomplete traces/movement trajectories. A movement trajectory is considered incomplete if it contains less than a certain number of measurements or if its starting position is closer than a certain distance (e.g. 30 m) from its end position.

Furthermore, in a further step, all movement trajectories using the same route are then found (swarm trajectories). For this purpose, a clustering algorithm 8 is used as a machine learning method. For this purpose, it is possible to use, for example, the DBSCAN algorithm (Density-Based Spatial Clustering of Applications with Noise) which is selected with regard to its parameters in such a way that at least all routes are found.

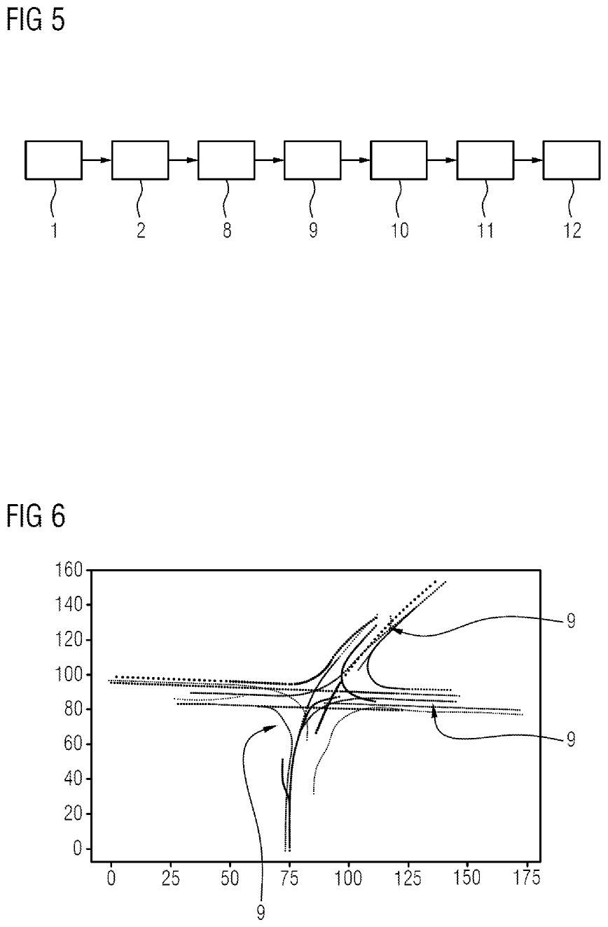

FIG. 6 shows the result of the clustering algorithm 8, which shows different example traces of respective clusters 9.

In a further step, an image processing algorithm 10 is used to obtain a contiguous line for each cluster 9. For example, the Gauss kernel can be used here. Alternatively, a skeletonization can be used. Skeletonization converts a planar image object into a pixel-wide, inner skeleton line.

This usually results in some routes that are only part of another route.

In a further step 10, unnecessary routes are therefore eliminated. To find them, each route is checked to see if there is a different route that is similar, for example close to these routes or similar to the course.

These sub-routes are no longer taken into account in the future steps. In a further step, the correct number of possible routes is now found using graph generation 11.

Each remaining route is converted into a directed graph. Therefore, each position of the route is considered to be a node of the graph. The respective edges of the graph are created by connecting each node to its best successor. The best successor is that node which is closest to the previously calculated direction of the node, with the limitation that it is in the same direction as the previously determined node.

After this step, each node has exactly one predecessor and one successor, except for the start and end positions.

In a further step, the lanes are divided. A Gaussian mixed model 12 can be used for this purpose. The nodes are divided into two lanes if different conditions are met.

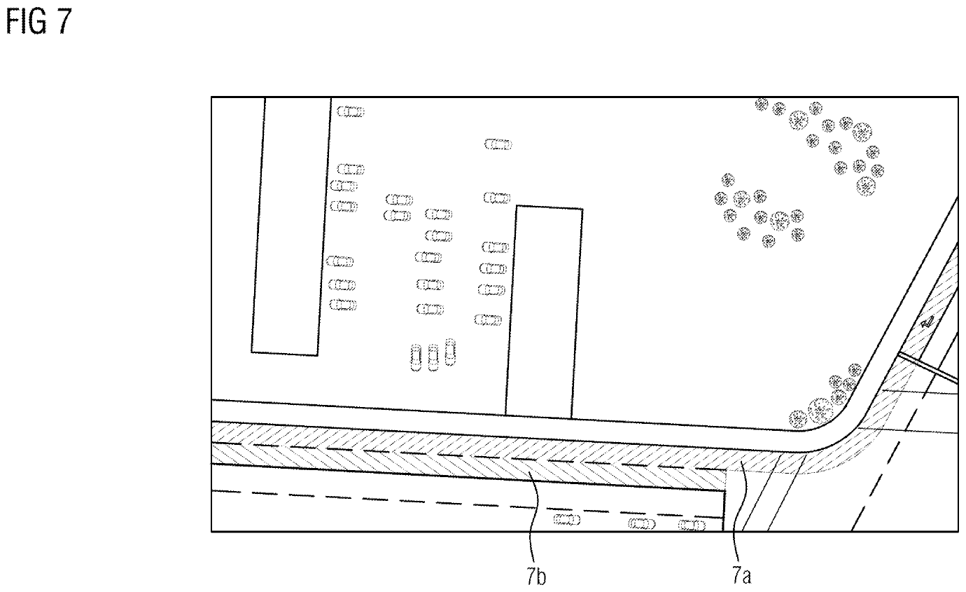

FIG. 7 shows such a division of one lane into two lanes 7a, 7b.

This allows a vector “map” to be created as a high-definition map for a respective road section. The differences between this map and conventional maps are that they can be created automatically from the collected data of the crowd, and the paths show the routes used in reality (swarm trajectories), not the routes expected by a planner. This vector “map” may thus contain additional information, such as where stopping is possible without hindering others, or where acceptable deviations from the optimal path are allowed.

Based on this vector map generated in this way as a high-definition map and using current movement data relating to the road user to be predicted, a future position of the road user can now be reliably determined.

By means of the predicted positions, dangerous situations of vulnerable road users can be detected and these road users can be warned in advance.

### LIST OF REFERENCE SIGNS

1 Storage unit
2 Processor
3, 3a Artificial neural network
4 First circles
5, 5a Second circles
6 Vehicle
7a, 7b Lanes
8 Clustering algorithm
9 Cluster
10 Route elimination step
11 Graph generation
12 Gaussian mixed model

1. A system for predicting a future position of road users in a predefined road section, comprising:
a storage unit in which at least historical sensor data relating to captured road users in a predefined road section are stored,
a processor which is configured to extract historical movement data relating to the captured road users from the historical sensor data and is further configured to learn a high-definition map of the predefined road section by a machine learning method based on the historical movement data, and
wherein the processor is further configured to determine, based on an input of current movement data relating to a road user, a prediction of at least one future position of the road user in the predefined road section, at least implicitly using the learned high-definition map.

2. The system as claimed in claim 1, wherein the road user comprises a plurality of road users and the at least one future position comprises a plurality of future positions of the road users, wherein the learned high-definition map is in the form of a trained artificial neural network, and wherein the system further comprises a computing unit configured for inputting the current movement data relating to the road users in the predefined road section into the trained artificial neural network generated in this way for predicting the future positions of the road users in the predefined road section.

3. The system as claimed in claim 2, wherein the processor is configured to generate the learned high-definition map as the trained artificial neural network at least based on relative historical positions of the road users as movement data, and wherein the computing unit is configured to generate the future positions of each road user when inputting the current movement data relating to the road users into the trained artificial neural network generated in this way.

4. The system as claimed in claim 3, wherein the movement data of the road users comprises, in addition to the relative historical positions of the road users, at least one of relative historical speeds of the road users, relative historical direction of the road users, or relative historical accelerations of the road users.

5. The system as claimed in claim 3, wherein the movement data comprises absolute historical positions coupled at least to the relative historical positions, and wherein the processor is configured to generate an absolute high-definition map as the trained artificial neural network at least using the historical relative positions and the absolute historical positions of the road users, and wherein the computing unit is configured to generate absolute future positions of the road user when inputting the current movement data relating to a road user into the trained artificial neural network generated in this way.

6. The system as claimed in claim 1, wherein the processor is configured to generate historical swarm trajectories from the historical movement data and is further configured to generate a vector map from the historical swarm trajectories as the learned high-definition map for the road section, and wherein the system further comprises a computing unit configured to generate the prediction of the at least one future position of the road user in the predefined road section using the current movement data and the vector map as the learned high-definition map.

7. A method for predicting a future position of road users in a predefined road section, comprising:
receiving, by a processor, at least historical sensor data relating to captured road users in a predefined road section,
extracting, by the processor, historical movement data relating to the captured road users from the historical sensor data and learning a high-definition map for the predefined road section by a machine learning method based on the historical movement data, and
determining, by the processor, based on current movement data relating to a road user, a prediction of at least one future position of the road user in the predefined road section, at least implicitly using the learned high-definition map.

8. The method as claimed in claim 7, wherein the road user comprises a plurality of road users and the at least one future position comprises a plurality of future positions of the road users, wherein the learned high-definition map is in the form of a trained artificial neural network, and the method further comprises inputting current movement data relating to the road users in the predefined road section into the trained artificial neural network for predicting the future positions of the road users in the predefined road section.

9. The method as claimed in claim 8, further comprising:
generating, by the processor, the high-definition map as the trained artificial neural network at least based on relative historical positions of the road users as movement data, and inputting current movement data relating to the road users into the trained artificial neural network in order to generate relative future positions of each road user.

10. The method as claimed in claim 9, further comprising:
generating, by the processor, an absolute high-definition map as the trained artificial neural network at least based on relative and absolute historical positions of the road users as movement data, and inputting current movement data relating to the road users into the trained artificial neural network generated in this way in order to generate absolute future positions of a road user.

11. The method as claimed in claim 7, wherein the road user comprises a plurality of road users and the at least one future position comprises a plurality of future positions of the road users, and the method further comprises:
generating, by the processor, historical swarm trajectories from the historical movement data, generating, by the processor, a vector map as the learned high-definition map for the predefined road section from the historical swarm trajectories, and generating the prediction of the future positions of the road users in the predefined road section using the current movement data and the vector map as the high-definition map.

12. The method as claimed in claim 11, further comprising:
generating historical movement trajectories with a predefined length from the detected historical movement data as relevant swarm trajectories.

13. The method as claimed in claim 12, further comprising:
clustering the same or similar historical movement trajectories and creating routes from the respective clusters.

14. An alarm system for warning vulnerable road users in the predefined road section using a method as claimed in claim 7 for predicting the at least one future position of the road user in the predefined road section.
